(19) United States
(12) Patent Application Publication
(10) Pub. No.: US 2023/0290060 A1
(43) Pub. Date: Sep. 14, 2023

(54) DERIVING METROLOGY DATA FOR AN OBJECT BASED ON ABSTRACT GEOMETRY DATA

(71) Applicant: Hewlett-Packard Development Company, L.P., Spring, TX (US)

(72) Inventors: Faisal Azhar, San Diego, CA (US); Markus Ernst Rilk, Palo Alto, CA (US); Sven Molkenstruck, Braunschweig (DE)

(73) Assignee: Hewlett-Packard Development Company, L.P., Spring, TX (US)

(21) Appl. No.: 18/007,226

(22) PCT Filed: Jul. 28, 2020
(86) PCT No.: PCT/US2020/043876

§ 371 Date: Jan. 27, 2023

(51) Int. Cl. G06T 17/20; G06T 7/70

(52) U.S. Cl. CPC G06T 17/20; G06T 7/70

(57) ABSTRACT

A method is described in which a partial three-dimensional model of an object is constructed in dependence on abstract geometry data. The abstract geometry data is indicative of an incomplete description of the object. The abstract geometry data comprises an indication of at least one geometric shape of the object and a design parameter associated with the at least one geometric shape. The partial three-dimensional model is aligned with three-dimensional scan data of an instance of the object. Based on the alignment, the pose of the at least one geometric shape is identified in the three-dimensional scan data. The pose of the geometric shape and the associated design parameter are used to derive metrology data for the instance of the object from the three-dimensional scan data.

An instance of a three-dimensional object may be produced using a manufacturing process, such as an additive manufacturing process which involves generating the instance of the object on a layer-by-layer basis. Such objects are often manufactured according to one or more design parameters. Once the instance of the object is manufactured, it is often useful to obtain data such as measurements of the instance of the object. Such measurements may be assessed against the design parameters to give an indication of the accuracy of the instance of the object and/or the manufacturing process.

### BRIEF DESCRIPTION OF THE DRAWINGS

Examples of the disclosure are further described hereinafter with reference to the accompanying drawings, in which:

FIG. 1 is a flowchart of a method for deriving metrology data according to an example;

FIG. 2 is a block diagram of abstract geometry data according to an example;

FIG. 3 is a flowchart of an example of a block of the method of FIG. 1;

FIG. 4 is a block diagram of inputs to a block of the method of FIG. 1;

FIG. 5 is a representation of a three-dimensional scan of an instance of an object;

FIG. 6 is a representation of a partial three-dimensional model constructed from abstract geometry data relating to a portion of the object of FIG. 5;

FIG. 7 is an illustration of an alignment between the three-dimensional scan of FIG. 5 and the partial three-dimensional model of FIG. 6;

FIG. 8 is an illustration of the scan of the instance of the object combined with geometric shapes identified in the scan;

FIG. 9 is a block diagram of an example apparatus according to the disclosure;

FIG. 10 is block diagram of a further example apparatus according to the disclosure; and

FIG. 11 is a schematic of an example machine-readable medium with a processor.

### DETAILED DESCRIPTION

Additive manufacturing techniques may generate an instance of a three-dimensional object through the solidification of a build material. In some examples, the build material may be a powder-like granular material, which may for example be a plastic, ceramic or metal powder. Build material may be deposited, for example on a print bed and processed layer by layer, for example within a fabrication chamber. Other manufacturing techniques, including for example subtractive manufacturing, casting, injection moulding and machining, may also be used to generate three-dimensional objects. Additive manufacturing may be referred to as three-dimensional printing.

Manufacturing systems, such as additive manufacturing systems, may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

Once an instance of an object has been manufactured according to a three-dimensional model, it is often desirable to measure the manufactured instance to assess the accuracy of the manufactured instance and the manufacturing process.

For objects that will be mass manufactured, it is possible to design bespoke measuring systems to take the desired measurements. However, for some manufacturing techniques such as additive manufacturing, the number of objects that will be manufactured is often small. Implementing bespoke metrology systems for instances of such objects is impractical, both in relation to time and cost. Furthermore, known methods of specifying the desired accuracy of a manufactured article may not take into account issues that may arise in the process of additive manufacturing.

Furthermore, in an additive manufacturing process, it may also be useful to deduce certain process control parameters of the manufacturing process. In some applications, this information may be more useful than specific measurements of the instance of the object. For additive manufacturing, it is useful to obtain scale and offset measurements of the instance of the object. Process control parameters may be derived from the scale and offset. The process control parameters may then be used of to correct the geometry of the printing process through either updates to the additive manufacturing apparatus calibration parameters or individualized pre-compensation of the specific part.

Obtaining a three-dimensional scan of the instance of the object is used to assess the manufactured object. Analysis of the scan of the instance of the object in comparison with the model can be used to provide information on the accuracy of the manufacturing process and the process control parameters of the manufacturing process. However, the three-dimensional model may be unavailable for use in comparison with the scan of the instance of the object. For example, proprietary restrictions may prevent the export of the three-dimensional model beyond the additive manufacturing system. The user may therefore only have an incomplete abstract geometrical description of the object highlighting certain design parameters. It may therefore be desired to compare the scan of the instance of the object to the user-provided abstract geometrical description to assess conformity of the object with design intent.

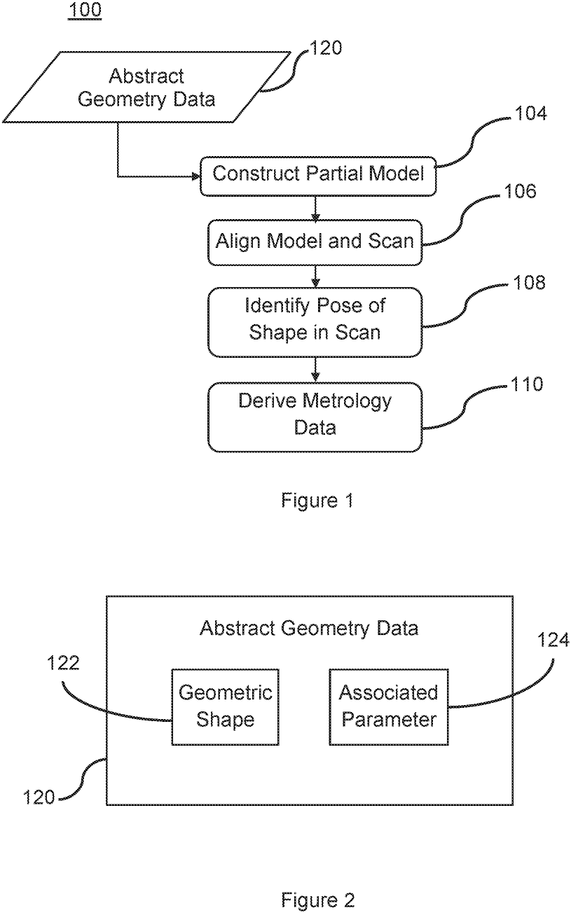

Referring now to FIG. 1, there is shown a flow chart of a method, indicated generally by the reference numeral 100, for deriving metrology data for an instance of an object. The method 100 enables the derivation of metrology data using only an incomplete abstract geometrical description of the object without requiring access to the full three-dimensional model of the object.

At block 104, the method 100 comprises constructing a partial three-dimensional model of the object in dependence on abstract geometry data 120. The abstract geometry data 120 is indicative of an incomplete description of the object, that is the information contained therein relates to a selected portion of the object. The abstract geometry data comprises an indication of at least one geometric shape of the object and a design parameter associated with the at least one geometric shape. The at least one predetermined geometric shape is associated with a surface of the object. The design parameter associated with the geometric shape may refer to any measurable aspect of the design, as will be explained. The partial three-dimensional model, also referred to henceforth as a partial model, may be considered to model a subset of the surfaces of the object, in particular those defined by the at least one predetermined geometric shape. The partial model may for example comprise a three-dimensional point cloud or a three-dimensional polygonal mesh. At block 106, the method 100 comprises aligning the partial model with three-dimensional scan data of an instance of the object. At block 108, the method 100 comprises identifying the pose of the at least one geometric shape in the three-dimensional scan data based on the alignment. As will be appreciated, identifying the pose may comprise identifying one or both of a position and an orientation of the predefined geometric shape. At block 110, the method comprises using the pose of the at least one predefined geometric shape and the associated parameter to derive metrology data for the instance of the object from the three-dimensional scan data. Obtaining metrology data in this manner is efficient and provides improved performance. Furthermore, it does not require use of a complete CAD mesh of the object, and thus provides flexibility to work with reduced design parameters.

Referring now to FIG. 2, there is shown a block diagram of abstract geometry data 120 according to the disclosure. The abstract geometry data 120 comprises at least one predefined geometric shape 122, and at least one associated parameter 124. The abstract geometry data 120 is used to construct the partial model in block 104.

The abstract geometry data 120 may be predefined by a user of the system to describe the design intent of a selected portion of the object. The object may be considered to be defined by a 3D surface, the 3D surface comprising a set of geometric shapes and the spatial relation between said shapes. For example, a cuboid object may be considered to be defined by six quadrilateral planes and their relation in terms of common edges. As discussed, the object may be manufactured using a three-dimensional model fully describing the 3D surface of said object. However, there is a need to provide automated metrology in the absence of the three-dimensional model, using only a partial description of the object. The abstract geometry data 120 may therefore comprise an indication of a subset of the geometric shapes defining the surface of the object. The abstract geometry data 120 may particularly comprise only the geometric shapes 122 and associated design parameters 124 which relate to a desired measurement. For example, if the object is a cuboid, it may be desired to measure the height of the cuboid. The geometric shapes 122 of the abstract geometry data 120 may then comprise a top rectangular face and a bottom rectangular face of the cuboid. The geometric shapes 122 may be defined for example in terms of vertices and edges.

The method 100 provides for fully automated metrology, using a reduced geometric description of design intent in the form of abstract geometry data, with improved accuracy and flexibility over what is available from the known alternatives. The object measurement process can be fully automated. Generating an object-specific inspection routine can be avoided, which is advantageous in relation to manufacturing small numbers of instances of objects, and/or highly customisable manufacturing processes.

Any geometric aspect of the instance of the object may be measured during an implementation of the method 100. The abstract geometry file may be constructed to correspond to a specific aspect of the object for which measurement is of interest. The aspect of interest may be defined as one or more predetermined shapes and associated design parameters in the abstract geometry file. Specifically defining these predetermined shapes and associated design parameters in the abstract geometry file enables the method 100 to be performed more efficiently than known alternatives. Corresponding geometric shapes may be efficiently identified in the scan for measurement. The measurements can be further analysed to provide scale and offset which can in turn be fed back into a manufacturing process to optimise or control the manufacturing process.

Scale and offset may be referred to as non-rigid deformation occurring in the instance of the object. The scale and offset of a part may vary depending where on a print bed of a 3D printer the part is printed. In some examples the scale and offset may therefore vary along a length of the instance of the object, and the scale and offset may be determined differently for portions of the instance of the object. The method 100 described herein may be used to identify deformations such as scale, offset, and errors in the relative orientation of the geometric shapes.

The method 100 may also be useful in determining other errors and deformations occurring in the instance of the object. Such other deformations may include sink in the upper surface of parts. Such sink may be the result of meniscus that forms as the instance of the object cools from molten to a solid state. Sink can be measured in terms of the deviation of the points that constitute a plane from the fitted plane. Identifying the extent of the sink may allow the process control parameters to be adjusted to reduce or eliminate the error in future instances of the object. The method 100 may also be useful identifying undesired or incorrect surface roughness or wrinkles on the surface of the instance of the object. In an example, the method may determine surface roughness and compare with an expected or nominal roughness, thus determining a “too rough” or “too smooth” surface. Additionally, the method 100 may identify large form errors in the instance of the object, for example, deviation from flatness in a plane, or deviation from sphericity of a sphere.

It will be understood that the methods taught herein have advantages in relation to a variety of manufacturing processes such as injection moulding or subtractive manufacturing but are also useful in relation to an additive manufacturing process.

The abstract geometry data 120 may be either manually created by a user or retrieved from memory. The geometric shapes 122 defined therein may be considered to represent a form or shape from which the shape of the object is composed. Such shapes may include planes, including irregularly shaped planes and regularly shaped planes; curved shapes such as spheres and cylinders; and additional shapes representing combinations of planar shapes and curved shapes, for example polyhedrons such as tetrahedrons, cubes, cuboids, and prisms. Generally, if a shape can be modelled, examples of that shape can be used to define a portion of the surface of the object in the abstract geometry data 120. Each geometric shape 122 may be defined in the abstract geometry data 120 as a collection of co-ordinates defining a boundary of said shape 122. The geometric shape 122 may be defined in a parametric reference scheme such as nonuniform rational B-spline (NURBS) representation or any alternative parametric representation. However, such an extensive definition of each geometric shape 122 may not be required. The geometric shape 122 may be defined in terms of one or more dimensions. For example, a sphere may be defined by specifying a radius, diameter or circumference of the sphere. A cube may be defined by specifying a length of an edge. Analogous equivalents will be appreciated to be readily derivable for other shapes.

The abstract geometry data 120 further comprises one or more design parameters 124 associated with the at least one geometric shape 122. Each design parameter simply relates to a measurable aspect of the design, and is not limiting to any particular type of design or representation. Each design parameter 124 may correspond to a measurement to be made on the instance of the object. The design parameter 124 may be a measurement between two separate geometric shapes 122 defined by the abstract geometry data 120, or a measurement within a single geometric shape 122. For example, where the geometric shapes 122 comprise a pair of parallel planes, the distance between the planes may be defined as a design parameter 124; where the geometric shape is a sphere, the design parameter may comprise a length of the radius of the sphere, or distance from the centre or surface of the sphere to another geometric shape 122. Each design parameter 124 may be explicitly or implicitly contained in the abstract geometry file. For example, the design parameter 124 may be explicitly represented as a numeric value of a desired measurement. However, the disclosure is not limited thereto and it will be appreciated that the design parameter 124 may be implicitly represented by the configuration of the geometric shapes 122. For example, a design parameter may be a relative orientation between two planes. Such an orientation may be implicitly contained in the abstract geometry data 120 because it is inferable from the definition of the two planes.

The abstract geometry data 120 may comprise a pose associated with each geometric shape 122. It will be appreciated that a pose of the geometric shape 122 may comprise one or both of a position or an orientation of the geometric shape 122. The pose may comprise a position of the geometric shape 122. The position may be an absolute position, for example a 3D location defined in a co-ordinate space. The position may alternatively be relative, for example a location of each geometric shape 122 relative to each other geometric shape 122. Similarly, the orientation may be an absolute orientation, for example defined by the 3D location of each vertex of the shape. The orientation may alternatively be relative, for example an orientation of each geometric shape 122 relative to each other geometric shape 122, for example defined as one or more angular offsets. In this way, a spatial arrangement of each defined geometric shape 122 may be derived to construct a partial model of the object in block 104.

The abstract geometry data may further comprise alignment data for use in aligning the constructed model with the scan in block 106. The alignment data may comprise one or more directional guides used to aid in aligning the constructed model with the scan data in the case of an object exhibiting symmetry, for example a cube. The directional guides may define approximate transformation ranges between the scanned object and a frame of reference for the defined geometric shapes. The directional guide may comprise a translation range or a rotation range, defining a range of transformation within which the alignment solution must lie. The directional guide may be predetermined based on a known orientation of the scanned object relative to the scanner. According to some examples of the disclosure, a scanned object may comprise an asymmetric label or tag detectable in the scan data. In this case the alignment data may comprise an indication of the position of the label or tag relative to the at least one geometric shape 122, which may then be aligned to the identified label or tag in the scan.

In the constructing block 104, a partial three-dimensional model, referred to henceforth also as a partial model, of the object is constructed in dependence on the abstract geometry data 120. The partial model may comprise a three-dimensional point cloud represented in a referential scheme as a list of vertices. According to some examples, the partial model may be constructed as a polygon mesh model. Such a polygon mesh model may be represented in a referential scheme as a list of vertices, faces and edges. By rendering the predefined geometric shapes 122 as a partial three-dimensional model, alignment techniques may be applied in block 106 to align the geometric shapes with the scan of the object. Constructing the partial model may comprise constructing a 3D point cloud comprising a series of 3D points, or vertices, on the surface of each geometric shape 122. Constructing the partial model may comprise constructing a series of edges or connections between said vertices to form a polygonal mesh. Any absolute pose, relative pose or design parameter associated with the geometric shape 122 in the abstract geometry data may be utilised to construct the 3D point cloud by relatively orienting each geometric shape 122 in 3D space. The information contained in the abstract geometry file 120 indicating each identified geometric shape 122, including any dimension, pose and associated design parameter 124 may therefore be utilised to construct the partial model. The partial model may be considered as an incomplete model of the object, or a model of a subsurface of the object. When implemented as a polygon mesh model, the partial model may be considered to be comprised of sub-meshes representing each geometric shape defined by the abstract geometry data 120. A subset of the vertices and edges of the partial model may be each assigned to correspond to each geometric shape 122 of the abstract geometry data 120.

In the aligning block 106, the partial model is aligned with the three-dimensional scan data. The scan data may be represented as a polygon mesh; as a point cloud of data points on the surface of the scanned object; or in another suitable format. If using a point cloud representation, the three-dimensional scan data may comprise the locations of a plurality of three-dimensional points on the surface of the instance of the object. Scan data in the form of a polygon mesh may include the locations of three-dimensional vertex points on the surface of the instance of the object and the edges connecting the vertex points. The scan data may be obtained in any suitable manner. Obtaining the scan data may include combining multiple three-dimensional scans of multiple views of the instance of the object, however useful metrology results may be obtained from scan data obtained from a single view.

The aligning may comprise providing an approximate alignment between the partial model and the three-dimensional scan data. As such, the alignment between the partial model and the scan data may be considered an approximate alignment. For example, the alignment may be accurate to within 1 mm and 1 °. The aligning block 106 adjusts the three-dimensional scan data to bring it into the same coordinate frame system as the partial model. The approximate alignment may be performed in dependence on an asymmetry of the partial model and a corresponding asymmetry of the scan data. An approximate alignment is acceptable as it is used as a starting point from which to identify the geometric shapes in the scan data. The alignment allows the recruitment of three-dimensional points in the scan data with respect to each of the geometric shapes identified in the partial model. Examples of mesh and point cloud alignment are (Winkelbach, S., Molkenstruck, S., and Wahl, F. M. (2006), Low-cost laser range scanner and fast surface registration approach, In Pattern Recognition, pages 718- 728. and Azhar, F., Pollard, S. and Adams, G. (2019) ‘Gaussian Curvature Criterion based Random Sample Matching for Improved 3D Registration’ at VISAPP) but it will be understood that the alignment described herein is not limited to these examples.

The aligning may comprise utilising any alignment data contained in the abstract geometry data 120, as described. The alignment data may provide an allowable range of transformation to be used in the alignment, or label data indicative of a label or marking on the object. The alignment data may be used to refine the approximate alignment or rule out inaccurate alignment solutions in the presence of partial symmetries in the object.

In block 108 of method 100, the pose of the geometric shapes in the partial model are identified in the scan data. Identifying the pose of the geometric shapes in the scan data may comprise identifying one or both of the position and orientation of the geometric shapes. Identifying the pose of the at least one geometric shape in the three-dimensional scan data may comprise associating a selection of the three-dimensional scan points with the geometric shape closest thereto. One or more further or alternative criteria may also be used to associate the three-dimensional scan points to the geometric shape. For example, the association may comprise a restriction that the scan point and associated geometric shape have a common surface normal direction. As such, the selected three-dimensional points of the scan data are associated with a geometric shape of the partial model. The identifying process may be understood to refer to a recruitment process where a selection of points in the scan are recruited into each geometric shape. Scan points are associated with a polygon in the partial model depending on one or more criteria, for example proximity and surface direction. For those faces in the scan data that are identified as belonging to geometrical shapes in the partial model, the scan points that are associated with them are thus associated with the corresponding geometrical shape instance. Identifying the pose of the at least one geometric shape in the three-dimensional scan data may further comprise processing the three-dimensional scan points associated with a geometric shape in the partial model to locate a corresponding geometric shape in the three-dimensional scan data.

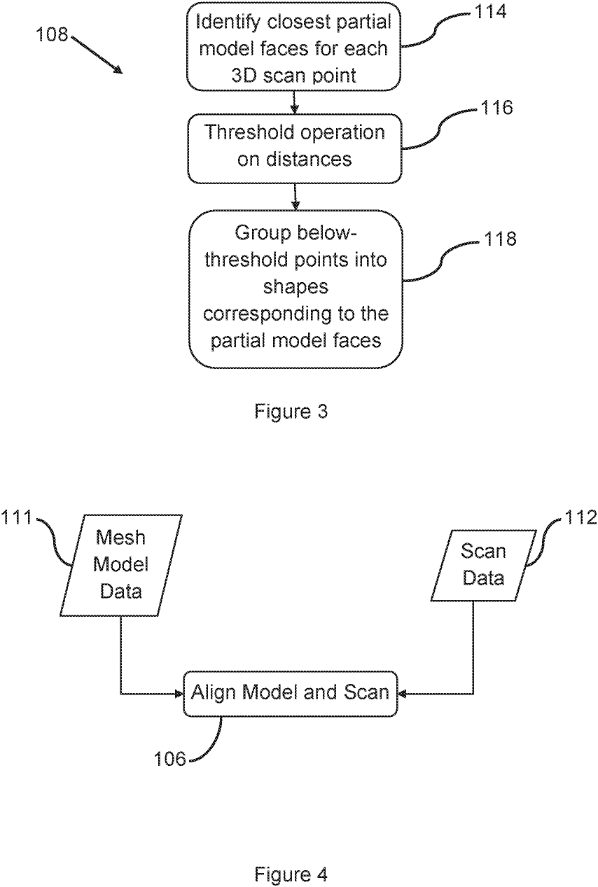

FIG. 3 shows an example implementation of block 108 including three sub-blocks. In the example implementation, the partial model has been constructed as a polygon mesh model. In sub-block 114, the distance from some or all of the three-dimensional points in the scan data to the polygonal faces of the partial model are calculated. Next, in sub-block 116, a threshold operation is carried out to identify the closest polygon faces for each scan point that are within a closest distance threshold. Then the three-dimensional points in the scan data with sub-threshold distance are thus grouped as geometric shapes corresponding to the geometric shapes in the partial model, based on the face in the partial model to which the three-dimensional scan point was closest.

In block 110, metrology data for the instance of the object is derived from the scan data using the pose of the at least one geometric shape in the scan data. In a first example, this comprises calculating measurements of features in the instance of the object from the scan data. The feature to be measured may correspond to one or more of the design parameters 124 identified in the abstract geometry data 120. Knowing the location of the identified geometric shapes in the scan data allows those geometric shapes to be used as references for taking the measurements. The measurements to be taken may be predefined by the at least one design parameter 124 in the abstract geometry data 120. As discussed, the design parameter may refer to a part of a geometric shape, or the distance between geometric shapes, and other physical aspects of the object. In block 110 measurements may be taken between two separate shapes, or within a single shape. For example, in the case where the geometric shapes comprise a pair of parallel planes, the design parameter may define a distance between the planes. In block 110, the distance between the planes in the scan data may be measured. Where the geometric shape is a single plane, the design parameter may define an accuracy or conformity to the plane surface. In block 110 the deviation of the three-dimensional scan points from a plane may thus be measured, and so on. As a further example, where the geometric shape is a sphere, the design parameter may define dimensions of a sphere, or distance from the centre or surface of the sphere to another feature of the object. In block 110, corresponding measurements of the sphere in the scan data may be taken.

In a second example of the derivation of metrology data in block 110, using the pose of the at least one geometric shape to derive metrology data may comprise calculating scale and offset parameters of the manufacturing process for the instance of the object. The printed instance of the object may be scaled differentially in the x, y and z directions with respect to the print bed and each of these scales may differ from the unity value that allows the instance of the object to be printed at its specified size. These scale parameters can be garnered from the appropriate components of measurements between the identified geometric shapes 122 in the scan data. The offset may also be referred to as the erosion and dilation of the surface material. For example, the thickness of the walls of a printed object may all be too thick if the offset is in the form of a dilation or too thin if the offset is in the form of an erosion. The size of the offset may also differ in each of the x, y and z directions. For a situation where the instance of the object is manufactured through additive manufacturing, on a print bed, and the instance of the object is aligned with the x, y, z axes of the print bed, it is possible to directly calculate the scale and offset by solving a simple linear relationship. In each dimension, scale and offset are the gradient and offset in the following linear equation:

$${y}_{i} = {x}_{i} m + {o}_{i} c \qquad \text{(1)}$$

where xᵢ and yᵢ are the partial model and scanned data measurements for this axis respectively; oᵢ is an offset inclusion parameter that is set to 1 where the two faces involved in a measurement are faces with opposite polarity and 0 otherwise, m is the gradient (scale) and c the offset (dilation/erosion of the surface material). The above equation can be represented as a system of equations,

$$Y = \left[\begin{matrix}X & O\end{matrix}\right] \left[\begin{matrix}m \\ c\end{matrix}\right] \qquad \text{(2)}$$

which may be solved using a linear least squares method. Similar equations can be used in the case where the planes are not directly aligned with major axis of the printer.

One type of measurements may include an offset, this type may be considered as “calliper type” measurements, for example between a pair of planes of opposite polarity or estimates of the diameter of a sphere. A second type of measurement does not include an offset, for example step heights where both surfaces have the same offset and it is not discernible, or distances between sphere centres.

Constructing a partial model from the abstract geometry data may be done separately to the remaining blocks of the method 100. FIG. 4 is a block diagram showing the data inputs to the aligning block 106. The aligning block 106 receives a partial model 111 of the object comprising the geometric shapes defined by the abstract geometry data. It further receives the three-dimensional scan data 112 of the manufactured instance of the object.

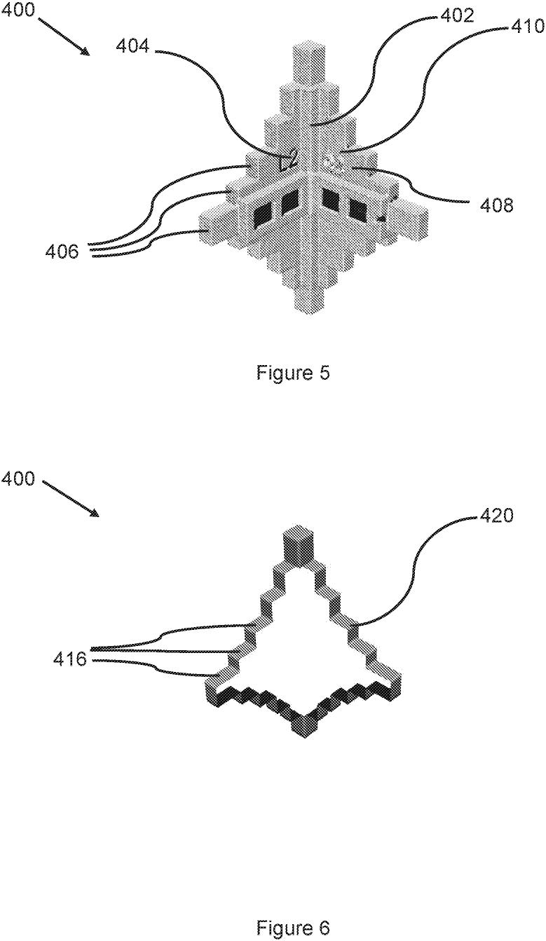

Referring now to FIGS. 5 to 8, there is illustrated an illustrative example according to the method 100 disclosed herein. FIG. 5 shows a representation of a three-dimensional scan 410 of an instance of an object 400 which may be referred to as a Corner. The object 400 comprises two perpendicular plates 404, 408. The plates abut at a common central spine 402, which may be considered to define a z axis. The perpendicular plates 404, 408 project orthogonally from the central spine 402 along an (x,z) plane and (y,z) plane respectively. Each perpendicular plate 404, 408 comprises an outer edge forming a series of steps 406. The steps are composed of a sequence of planes, in alternation parallel and orthogonal to the axis of the central spine 402.

The full three-dimensional model from which the object 400 was manufactured may not be available, yet it may be desired to measure one or more features of the object 400 against design intent. According to the illustrated example, abstract geometry data may be defined to express design parameters for the object 400. In this example, the abstract geometry data may define, as the predetermined geometric shapes 122, the plurality of planes forming the series of steps 406 of the object. The abstract geometry data may define as the at least one associated design parameter, the height and width of each step 406. By using only such a reduced description of the overall object 400, the method 100 enables automated metrology of the object 100.

FIG. 6 illustrates an example partial three-dimensional model 420 of the object 400 constructed from the abstract geometry file. The illustrated partial three-dimensional model 420 comprises a three-dimensional rendering of a plurality of planes 416 defined by the abstract geometry data. The partial three-dimensional model 420 is constructed as a polygon mesh model. It can be seen that the partial three-dimensional model 420 of the object 400 is a model of a subset of the surface of the object 400 according to the intended design parameters.

In FIG. 6, it will be appreciated that only a subset of the planes 416 are labelled for illustrative purposes. However, it will be appreciated by the skilled person that the example illustrated by the planes 416 may be extrapolated to any other plane or alternative geometric shape defined in the abstract geometry data.

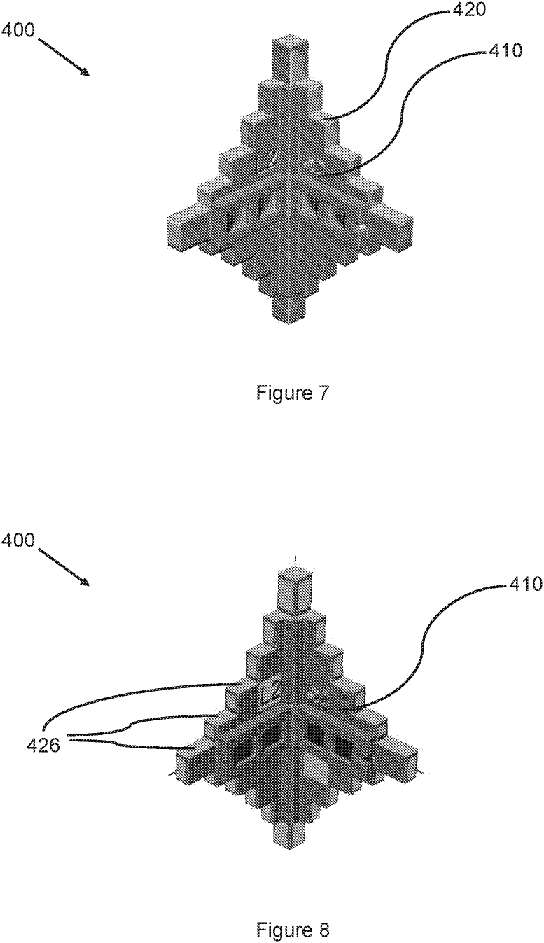

Referring now to FIG. 7, there is shown a representation of the scan 410 of the instance of the object 400 aligned with the partial three-dimensional model 420 following implementation of an example of the aligning block 106.

After the scan data 410 is aligned with the partial model 420, a sub-set of points from the scan data is selected. An automatic plane fitting process is performed on the selected points in the scan data that have been associated with corresponding planes 416 in the partial model 420. For the points grouped into each nominal plane, those groups of planes at the same nominal orientation may be combined for a multi-plane fit. This may comprise categorising the significant planes are categorised according to co-planarity, common surface normal, and opposite planarity. An example plane fitting method may use an iterative weighted least squares version of M-Estimation with a Turkey weighting function to eliminate any outlier points that may have been incorrectly included in a plane. Such incorrect inclusion may arise for a number of reasons, for example due to the approximate alignment of the partial model 420 and scan data 410, or due to noisy or erroneous scan data.

FIG. 8 illustrates example planes 426 identified in the three-dimensional scan of the object 400 corresponding to the planes 416 of the partial model following the block 108. The identified planes 426 are illustrated in FIG. 8 superimposed on the original scan data 410.

Based on grouped planar measurements, it is possible to obtain metrology data for the object 400, for example by computing individual plane-to-plane measurements, such as the perpendicular distance between the planes 426. It is also possible to measure the relative orientation of planes. These measurements may then be compared with corresponding design parameters from the abstract geometry data for an indication of accuracy of the instance of the object.

It may be helpful when fitting planes to ignore regions close to the edge of the plane by shrinking the individual planes that form the partial model. This introduces a guard band around the points that are recruited form a specific plane and makes it less likely to recruit points belonging to adjacent surfaces in the presence of small residual misalignment of the partial model against the scanned point cloud. If a second candidate plane with a further degree of shrink factor (larger than the first) is also sought, then the difference between the fitted planes in the direction of a common normal will be indicative of the degree of sink present in the printed plane.

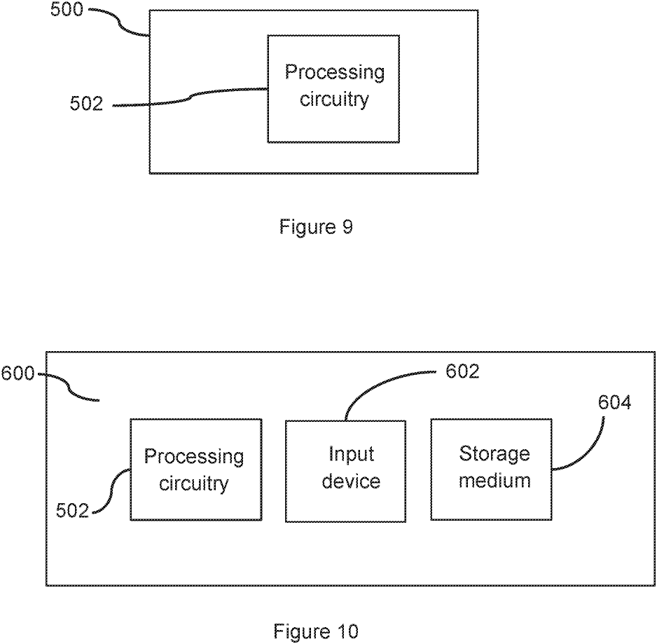

According to some examples, an apparatus may be controlled to perform the method 100 discussed above. FIG. 9 is a simplified schematic of an example of an apparatus 500 for deriving metrology data for the instance of the object from a scan of the instance of the object. The apparatus 500 may comprise processing circuitry 502. The processing circuitry 502 may determine a partial three-dimensional model of an object in dependence on abstract geometry data. The abstract geometry data may be indicative of an incomplete description of the object and comprise an indication of at least one geometric shape of the object and a design parameter associated with the at least one geometric shape. In some examples, the processing circuitry 502 may perform an alignment between the partial three-dimensional model and the three-dimensional scan data of an instance of the object. The processing circuitry 502 may identify the pose of the at least one geometric shape in the aligned three-dimensional scan data. The processing circuitry 502 may obtain metrology data for the instance of the object using the pose of the at least one predefined geometric shape and the associated design parameter. In some examples, the processing circuitry 502 may calculate at least one measurement for the instance of the object from the three-dimensional scan data in dependence on the pose of the geometric shape and the associated design parameter. The processing circuitry 502 may calculate the scale and offset parameters for the instance of the object, and may further derive from the scale and offset parameters process control parameters for an additive manufacturing process that manufactured the instance of the object. This is an efficient method of obtaining these process control parameters.

The processing circuitry 502 may comprise circuitry within a computing device, which may form part of, or be associated with, an additive manufacturing apparatus.

FIG. 10 is a simplified schematic of an example of an apparatus 600 for deriving metrology data for the instance of the object. The apparatus 600 may comprise the processing circuitry 502. In some examples, the apparatus 600 may further comprise a user input device 602 to enable a user to select the geometric shapes and associated design parameters to be used in the abstract geometry data 120. The user input device 602 may, for example, comprise a keyboard, a mouse, a touchpad or a touchscreen.

The apparatus 600 may, in some examples, comprise a storage medium 604 to store details of the abstract geometry data, the partial model, the scan data, the locations of geometric shapes within the scan data; and other information relevant to the methods and examples disclosed herein.

In some examples, the apparatus 600 may comprise processing circuitry 502 to construct a partial three-dimensional model of an object in dependence on abstract geometry data indicative of an incomplete description of the object, the abstract geometry data comprising an indication of at least one geometric shape of the object and a design parameter associated with the at least one geometric shape; align the partial three-dimensional model with three-dimensional scan data of an instance of the object; based on the alignment, identifying the pose of the at least one geometric shape in the three-dimensional scan data; and using the pose of the geometric shape and the associated design parameter to derive metrology data for the instance of the object from the three-dimensional scan data.

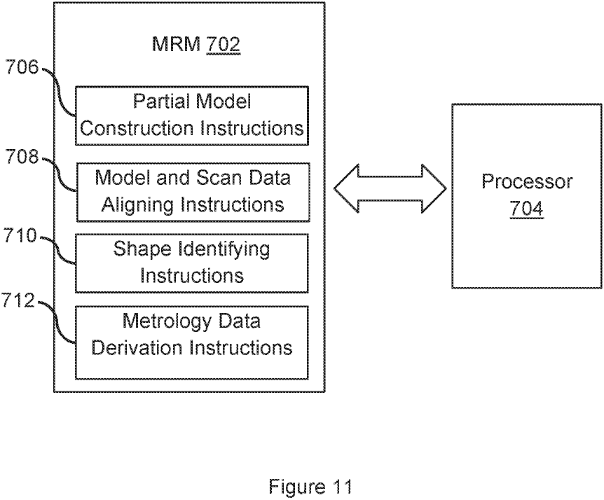

FIG. 11 is a schematic of an example machine-readable medium 702 with a processor 704. The machine-readable medium 702 may comprise instructions which, when executed by a processor 704, cause the processor to perform the method 100 discussed above.

The machine-readable medium 702 may comprise instructions which, when executed by a processor 704, cause the processor to partially model the object as a three dimensional model in dependence on abstract geometry data, the abstract geometry data being indicative of an incomplete description of the object and comprising an indication of at least one geometric shape of the object and a design parameter associated with the at least one geometric shape. The machine-readable medium 702 may comprise partial model construction instructions 706 to perform the modelling.

The machine-readable medium 702 may comprise instructions which, when executed by a processor 704, cause the processor to align the three dimensional model with three-dimensional scan data of an instance of the object. The machine-readable instructions may comprise model and scan data aligning instructions 708 to perform the alignment.

The machine-readable medium 702 may comprise instructions which, when executed by a processor 704, cause the processor to identify the at least one geometric shape in the three-dimensional scan data in dependence on the alignment. The machine-readable medium 702 may comprise shape identifying instructions to identify the geometric shape.

The machine-readable medium 702 may comprise instructions which, when executed by a processor 704, cause the processor to use the identified geometric shape in the scan data and the associated design parameter to derive metrology data for the instance of the object from the three-dimensional scan data. The machine-readable medium 702 may comprise metrology data derivation instructions 712 to derive the data.

In some examples, the machine-readable medium 702 may comprise additional instructions which, when executed by a processor 704, cause the processor to perform further actions in line with the methods and examples described herein. In some examples, the machine-readable medium 702 may comprise instructions, which when executed by the processor 704, cause the processor 704 to construct a partial three-dimensional model of an object in dependence on abstract geometry data indicative of an incomplete description of the object, the abstract geometry data comprising an indication of at least one geometric shape of the object and a design parameter associated with the at least one geometric shape; align the partial three-dimensional model with three-dimensional scan data of an instance of the object; based on the alignment, identifying the position of the at least one geometric shape in the three-dimensional scan data; and using the position of the geometric shape and the associated design parameter to derive metrology data for the instance of the object from the three-dimensional scan data.

Examples in the present disclosure can be provided as methods, systems or machine-readable instructions, such as any combination of computer programme code, hardware, or the like. Such machine-readable instructions may be included on a machine-readable medium having computer readable program codes therein or thereon. The machine-readable medium can be realised using any type or volatile or non-volatile (non-transitory) storage such as, for example, memory, a ROM, RAM, EEPROM, optical storage and the like. The machine-readable medium may be a non-transitory machine-readable medium. The machine-readable medium may also be referred to as a computer-readable storage medium.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by processing circuitry. The processing circuitry, for example the processing circuitry 502 referred to in relation to FIGS. 9 and 10 may be in the form of or comprised within a computing device. Such a computing device may include a general purpose computer, a special purpose computer, an embedded processor or processors or other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure. The methods and examples taught herein provide for fully automated metrology from a reduced description of design intent, with improved accuracy and flexibility than over what is available from the known alternatives. The object measurement process can be fully automated. This automatic metrology method eliminates the requirement for designing and implementing part-specific inspection routines, which is particularly advantageous in relation to manufacturing small numbers of objects, and/or highly customisable manufacturing processes. The measurements can be further analysed to provide automatic print control parameters such as scale and offset, which can in turn be fed back into a manufacturing process to optimise or control the manufacturing process. The methods may also allow identification of other deformations such as sinks, and surface deformations such as wrinkling.

While the method, apparatus and related aspects have been described with reference to certain examples, various modifications, changes, omissions, and substitutions can be made without departing from the scope of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

Throughout the description and claims, a number of threshold values have been identified and example values provided. It will be understood that threshold values other than those suggested in the examples may be used and will still fall within the scope of the disclosure.

The features of any dependent claim may be combined with the features of any of the independent claims or other dependent claims.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise. A single processor or other unit may fulfil the functions of several units recited in the claims.

The reader’s attention is directed to all papers and documents which are filed concurrently with or previous to this specification in connection with this application and which are open to public inspection with this specification.

Aspects of the disclosure are provided by the following numbered clauses:

1. A method comprising:
constructing a partial three-dimensional model of an object in dependence on abstract geometry data indicative of an incomplete description of the object, the abstract geometry data comprising an indication of at least one geometric shape of the object and a design parameter associated with the at least one geometric shape;
aligning the partial three-dimensional model with three-dimensional scan data of an instance of the object;
based on the alignment, identifying the pose of the at least one geometric shape in the three-dimensional scan data; and
using the pose of the geometric shape and the associated design parameter to derive metrology data for the instance of the object from the three-dimensional scan data.

2. The method of clause 1 wherein the abstract geometry data comprises a pose associated with each geometric shape and wherein the partial three-dimensional model is constructed based on the pose of each geometric shape.

3. The method of any preceding clause wherein the at least one geometric shape comprises one or more of a plane, a sphere, a cone, a cuboid and a cylinder.

4. The method of any preceding clause wherein the abstract geometry data comprises a first geometric shape and a second geometric shape, and wherein the associated design parameter comprises a distance between the first geometric shape and the second geometric shape.

5. The method of any preceding clause wherein constructing a partial three-dimensional model comprises constructing a 3D point cloud comprising each geometric shape in dependence on the associated design parameter indicated in the abstract geometry data.

6. The method of any preceding clause wherein the abstract geometry data comprises alignment data and the aligning the constructed partial three-dimensional model with the three-dimensional scan data is performed in dependence on the alignment data.

7. The method of any preceding clause wherein the aligning comprises providing an approximate alignment between the partial three-dimensional model and the three-dimensional scan data.

8. The method of clause 7 wherein the approximate alignment is provided based on an asymmetry of the partial three-dimensional model and an asymmetry of the three-dimensional scan data.

9. The method of any preceding clause wherein the three-dimensional scan data comprises a polygonal mesh including the locations of a plurality of vertex points on the surface of the instance of the object.

10. The method of clause 9 wherein the identifying the pose of the at least one geometric shape in the three-dimensional scan data comprises:
associating a selection of the three-dimensional scan points with the geometric shape closest thereto in the aligned partial three-dimensional model; and
processing the three-dimensional scan points associated with the geometric shape in the partial three-dimensional model to locate a corresponding geometric shape in the three-dimensional scan data.

11. The method of any preceding clause, wherein the using the pose of the at least one geometric shape and the associated design parameter to derive metrology data comprises measuring a corresponding parameter associated with the at least one geometric shape in the instance of the object.

12. The method of any preceding clause wherein using the pose of the at least one geometric shape to derive metrology data comprises calculating scale and offset parameters for the instance of the object.

13. The method of clause 12 comprising deriving, from the scale and offset parameters, process control parameters for an additive manufacturing process that manufactured the instance of the object.

14. A machine-readable medium comprising instructions, which when executed by a processor, cause the processor to perform the method of any of clauses 1 to 13.

15. An apparatus comprising processing circuitry to perform the method of any of clauses 1 to 13.

16. An apparatus comprising processing circuitry to:
determine a partial three-dimensional model of an object in dependence on abstract geometry data indicative of an incomplete description of the object, the abstract geometry data comprising an indication of at least one geometric shape of the object and a design parameter associated with the at least one geometric shape;
perform an alignment between the partial three-dimensional model and three-dimensional scan data of an instance of the object;
identify the pose of the at least one geometric shape in the aligned three-dimensional scan data; and
calculate at least one measurement for the instance of the object from the three-dimensional scan data in dependence on the position of the geometric shape and the associated design parameter.

17. A machine-readable medium comprising instructions, which when executed by a processor, cause the processor to:
partially model the object as a three-dimensional model in dependence on abstract geometry data indicative of an incomplete description of the object, the abstract geometry data comprising an indication of at least one geometric shape of the object and a design parameter associated with the at least one geometric shape;
align the partial three-dimensional model with three-dimensional scan data of an instance of the object;
identify the at least one geometric shape in the three-dimensional scan data in dependence on the alignment; and
use the identified geometric shape in the scan data and the associated design parameter to derive metrology data for the instance of the object from the three-dimensional scan data.

1. A method comprising:
constructing a partial three-dimensional model of an object in dependence on abstract geometry data indicative of an incomplete description of the object, the abstract geometry data comprising an indication of at least one geometric shape of the object and a design parameter associated with the at least one geometric shape;
aligning the partial three-dimensional model with three-dimensional scan data of an instance of the object;
based on the alignment, identifying the pose of the at least one geometric shape in the three-dimensional scan data; and
using the pose of the geometric shape and the associated design parameter to derive metrology data for the instance of the object from the three-dimensional scan data.

2. The method as claimed in claim 1 wherein the abstract geometry data comprises a pose associated with each geometric shape and wherein the partial three-dimensional model is constructed based on the pose of each geometric shape.

3. The method as claimed in claim 1 wherein the at least one geometric shape comprises one or more of a plane, a sphere, a cone, a cuboid and a cylinder.

4. The method as claimed in claim 1 wherein the abstract geometry data comprises a first geometric shape and a second geometric shape, and wherein the associated design parameter comprises a distance between the first geometric shape and the second geometric shape.

5. The method as claimed in claim 1 wherein constructing a partial three-dimensional model comprises constructing a 3D point cloud comprising each geometric shape in dependence on the associated design parameter indicated in the abstract geometry data.

6. The method as claimed in any preceding claim wherein the abstract geometry data comprises alignment data and the aligning the constructed partial three-dimensional model with the three-dimensional scan data is performed in dependence on the alignment data.

7. The method as claimed in claim 1 wherein the aligning comprises providing an approximate alignment between the partial three-dimensional model and the three-dimensional scan data.

8. The method as claimed in claim 7 wherein the approximate alignment is provided based on an asymmetry of the partial three-dimensional model and an asymmetry of the three-dimensional scan data.

9. The method as claimed in claim 1 wherein the three-dimensional scan data comprises a polygonal mesh including the locations of a plurality of vertex points on the surface of the instance of the object.

10. The method as claimed in claim 9 wherein the identifying the pose of the at least one geometric shape in the three-dimensional scan data comprises:
associating a selection of the three-dimensional scan points with the geometric shape closest thereto in the aligned partial three-dimensional model; and
processing the three-dimensional scan points associated with the geometric shape in the partial three-dimensional model to locate a corresponding geometric shape in the three-dimensional scan data.

11. The method as claimed in claim 1, wherein the using the pose of the at least one geometric shape and the associated design parameter to derive metrology data comprises measuring a corresponding parameter associated with the at least one geometric shape in the instance of the object.

12. The method as claimed in claim 1 wherein using the pose of the at least one geometric shape to derive metrology data comprises calculating scale and offset parameters for the instance of the object.

13. The method as claimed in claim 12 comprising deriving, from the scale and offset parameters, process control parameters for an additive manufacturing process that manufactured the instance of the object.

14. An apparatus comprising processing circuitry to:
determine a partial three-dimensional model of an object in dependence on abstract geometry data indicative of an incomplete description of the object, the abstract geometry data comprising an indication of at least one geometric shape of the object and a design parameter associated with the at least one geometric shape;
perform an alignment between the partial three-dimensional model and three-dimensional scan data of an instance of the object;
identify the pose of the at least one geometric shape in the aligned three-dimensional scan data; and
calculate at least one measurement for the instance of the object from the three-dimensional scan data in dependence on the pose of the geometric shape and the associated design parameter.

15. A machine-readable medium comprising instructions, which when executed by a processor, cause the processor to:
partially model the object as a three-dimensional model in dependence on abstract geometry data indicative of an incomplete description of the object, the abstract geometry data comprising an indication of at least one geometric shape of the object and a design parameter associated with the at least one geometric shape;
align the partial three-dimensional model with three-dimensional scan data of an instance of the object;
identify the at least one geometric shape in the three-dimensional scan data in dependence on the alignment; and
use the identified geometric shape in the scan data and the associated design parameter to derive metrology data for the instance of the object from the three-dimensional scan data.
